(19) United States
(12) Patent Application Publication
(10) Pub. No.: US 2014/0172730 A1
(43) Pub. Date: Jun. 19, 2014

(54) Method to Track Transfer of Goods

(71) Applicant: Lebohang Phillip MAPHOTHOANE, Hlotse Lisemeng (LS)

(72) Inventor: Lebohang Phillip MAPHOTHOANE, Hlotse Lisemeng (LS)

(21) Appl. No.: 14/105,601

(22) Filed: Dec. 13, 2013

(30) Foreign Application Priority Data
Dec. 14, 2012 (ZA) 2012/09520

(51) Int. Cl. G06Q 10/08; G06Q 50/00

(52) U.S. Cl. CPC G06Q 10/0833; G06Q 50/01
USPC 705/319

(57) ABSTRACT

A method to track transfer of goods on a social networking service, which includes associating at least one unique product identification number with at least a first user profile on a social network service and facilitating transfer of the at least one unique product identification number from the first user profile to a second user profile on a social network service.

THIS INVENTION relates to an electronic tracking method. In particular, the invention relates to a method to track transfer of goods on a social networking service and to a social networking service application.

### BACKGROUND OF THE INVENTION

The inventor is aware of other electronic tracking methods to identify counterfeit goods such as medicines. This method, however, comprises verification of the ingenuity of the product by sending a unique product identification number via a short message service (sms) message to a call centre. A response from the call centre via reply to the sms, verifies that the product is genuine.

The inventor identified a need for an electronic method to identify counterfeit goods by tracking sale or purchase of goods on a social networking service, including medicine, clothes, food products, vehicles or the like.

The present invention aims to address this need.

### SUMMARY OF THE INVENTION

According to one aspect of the invention, there is provided a method to track transfer of goods on a social networking service, which includes:

associating at least one unique product identification number with at least a first user profile on a social network service; and
facilitating transfer of the at least one unique product identification number from the first user profile to a second user profile on a social network service.

The method may include a prior step of registering at least two user profiles on a social network service.

The method may include the prior step of allocating the unique product identification number to goods to be transferred from the first user profile to the second user profile. Goods may include merchandise like clothing, manufactured products, pharmaceutical products, vehicles or the like.

Allocating the unique product identification number to goods may include creating a unique machine-readable tag.

The machine-readable tag may include any one of an optical readable label, such as a barcode or a quick response (QR) code, and a contactless radio-frequency identification tag.

The registering of the at least two user profiles on a social network service may include creating a user profile, comprising of unique user identification data.

The user identification data may include a name and surname, a physical address, contact details of a user, and an identification picture, or the like.

Facilitating transfer of at least one unique product identification number may include associating the at least one unique product identification number with a second user profile and dissociating the unique product identification number from the first user profile.

Facilitating transfer of the at least one unique product identification number may be related to the transfer of goods from a first owner to a second owner such as from a seller to a buyer. For example, when a shopper buys goods from a retail store or for another example when a person buys a vehicle from a motor dealer.

The facilitating transfer of at least one unique product identification number may include obtaining authorisation from a government institution for the transfer of goods, such as the traffic police for the transfer of a vehicle.

A social networking service application, which includes:

a social networking service user profile database;

a unique product identification database containing product identification numbers; and

association means operable to associate unique product identification numbers from the product identification database with user profiles from the user profile database.

The association means may be in the form of a lookup table comprising user profile data, and unique product identification data, associated with each other.

The user profile database may include data fields comprising any one or more of user names, addresses, contact details for the users, and an identification picture, or the like.

The unique product identification database may include data fields comprising any one or more of a barcode, a QR code and a product description, or the like.

The invention will now be described, by way of example only, with reference to the following drawings.

### DRAWINGS

In the drawings:

FIG. 1 shows a block diagram of a method to track transfer of goods on a social networking service in accordance with one aspect of the invention; and

FIG. 2 shows an illustrated diagram of an embodiment of the invention.

FIG. 3 shows a flow diagram of the method in FIG. 1, in use.

### EMBODIMENT OF THE INVENTION

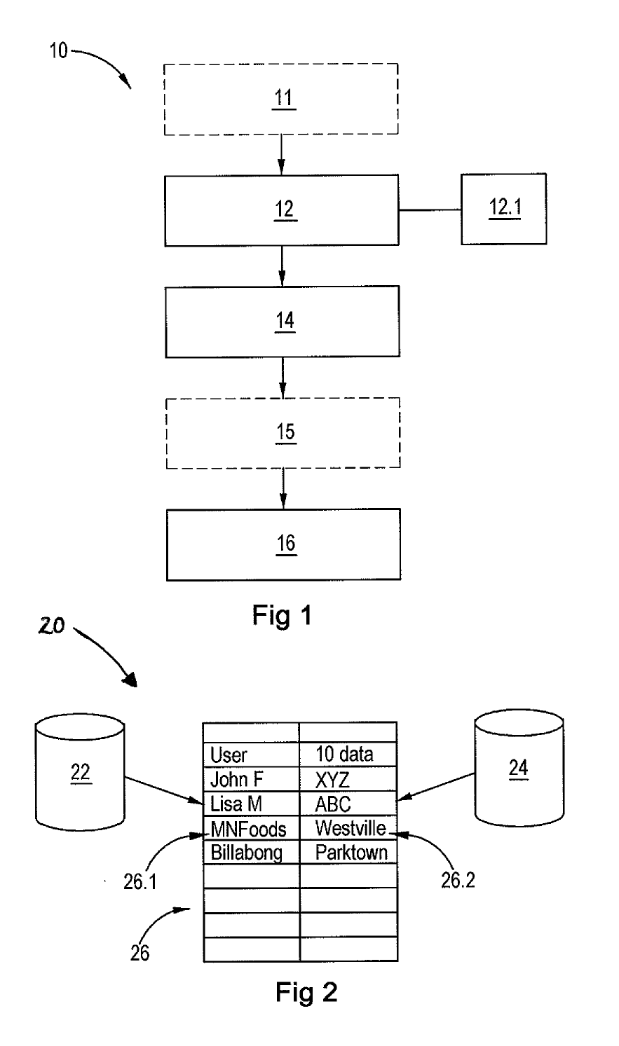

In FIG. 1 a block diagram of a method 10 to record sold and bought goods on a social networking service is shown.

The first step of this method 10 is shown at 11 where a unique product identification number is allocated to goods that are for sale. The next step of this method 10 is shown at 12, where at least two user profiles are registered on the social networking service. Following registration, the unique product identification number is associated with one of the user profiles at 14, so that transfer of the product identification number from one of the user profiles to another can be facilitated at 16.

The goods mentioned can be any merchandise like clothing, manufactured products, pharmaceuticals, vehicles or the like. It is to be appreciated that the unique product identification number can also be allocated to the goods by way of creating a unique machine-readable tag. The machine-readable tag can be an optical readable label, such as a barcode or a quick response (QR) code. The machine-readable tag can also be a contactless radio-frequency identification tag.

During registration of the user profile on the social networking service at 12, a user account is opened with unique identification data associated with that user profile at 12.1. The identification data can include any information i.e. the names, address, identification picture and contact details of the user.

In order to facilitate the transfer of a unique product identification number from a first user profile to a second user profile at 16, the product identification number is associated with the second user profile and dissociated from the first user profile. When transferring the unique product identification number from the first user profile to the second user profile, the identification number is transferred from a first owner to a second owner. The first owner can be a seller and the second owner can be a buyer. For example, when a shopper buys goods from a retail store the number associated with the goods is transferred from the retail store (first owner) to the shopper so that the shopper becomes the second or new owner of the goods. A second example is where a person buys a vehicle from a motor dealer. Similar to the previous example, the number allocated to the vehicle and associated with the dealer on the social networking service, is transferred from the dealer to the person, buying the vehicle. This way, the dealer will no longer appear as the owner of the vehicle but the person who bought the vehicle will be the owner.

When a person buys a previously owned or used vehicle, police clearance is required to show that the vehicle is not stolen. It is therefore to be appreciated that in order for the product identification number to be transferred from the first owner to the new owner, a government institution such as the police needs to authorise the transfer of a vehicle at 15.

The method terminates at 16.

This method is particularly applicable to track original products or goods. For example, a unique, original product is manufactured in a factory. The goods are then transferred to a store, where the goods are to be sold or distributed from. The goods are then transferred to a first user. It may then happen than a first user then transfers the goods to a further user. The date and time of the transfer can be logged to create an audit trail on which the transfers can be tracked.

For example: Nike manufacture (04-03-2013)>Nike Retail store (09-05-2013)>John shoes (26-07-2013)>Thabo Neo.

The above chain of events illustrates how original goods can be tracked to avoid counterfeit goods from being distributed. The audit trail of the transfer of goods will then also be subject to security provisions so that only registered users are permitted to transfer the particular goods.

In FIG. 2, an embodiment of the invention is illustrated by way of a social networking service application 20. Such an application includes a user profile database 22 and a unique product identification database 24. The application also includes association means which is used to associate the unique product identification number 26.2, retrieved from the product identification database 24, with the first user profile from the user profile database 22.

It is appreciated that the association means can be in the form of a lookup table 26 that comprises user profile data 26.1 associated with unique product identification data 26.2.

The user profile database 22 can include data fields comprising any information about the users, including user names, addresses, identification picture, contact details for the users, or the like.

The unique product identification database can include data fields comprising a barcode including the selling price of the product, QR code, product description, or the like.

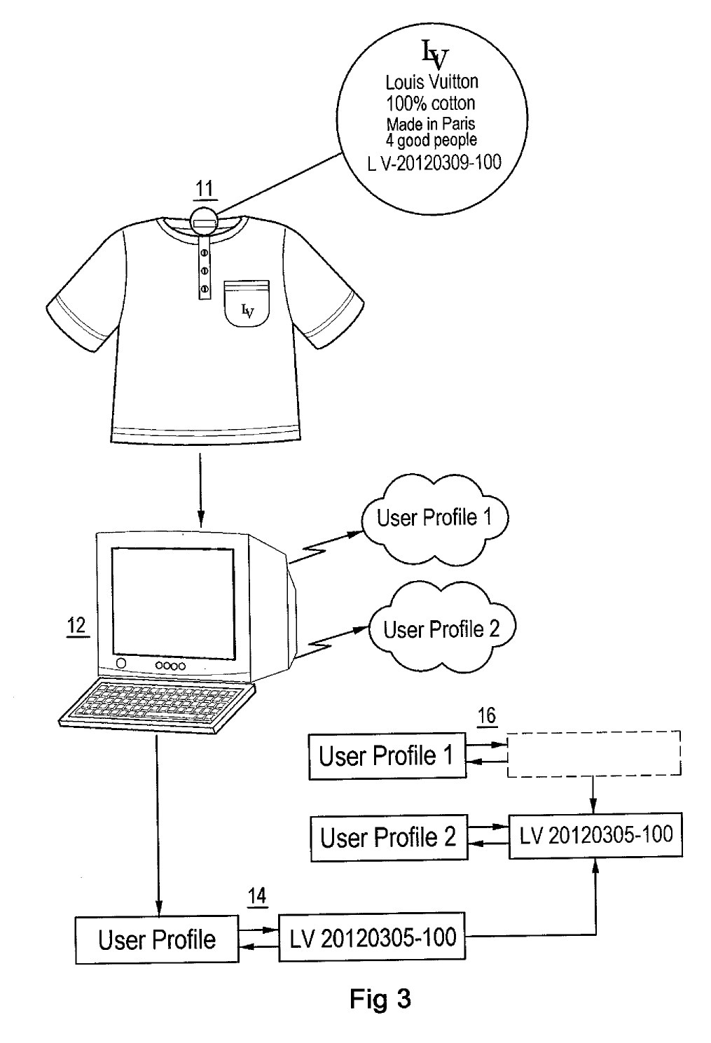

In use, the method supports the identification of counterfeit goods via current communication mediums such as a social networking service, as shown in FIG. 3. With this method, alphanumeric identification numbers are allocated, during manufacturing of the products, to all products for sale in a store at 11. These numbers are then logged on to the store's user account on the social networking service at 12, so that the products associated with the numbers reflect as the owner's of the store on the service as shown at 14. As soon as the product is sold, the owner logs onto the store's user account and transfer the identification number of the product to the buyer's user account at 16. In case the buyer do not have an account, the seller will request the identification number or passport number of the seller and then the buyer will transfer the identification number of the product to the buyer's identification number or passport number. The account will be created automatically in the system, using the identification number or passport number. The identification number or passport number will be the identification detail of the buyer's account. Once the number is transferred, the owner is no longer associated with the product and the buyer reflects as the new owner of the product.

This way, when a potential buyer wants to buy a product with a certain identification number at a selected store, the buyer may log on to any other retail store's user account to determine whether the identification number on the product match the products in the retail store. If the numbers match, the buyer can confirm that the product is original. If the product identification number does not match the number associated with the products in the retail store, the buyer will know that the product is fake.

The inventor is of the opinion that the invention, as described provides a method to track transfer of goods on a social networking service, which will be of great benefit to users to identify whether they are buying original or counterfeit goods.

What is claimed is:

1. A method to track transfer of goods on a social networking service, which includes:
associating at least one unique product identification number with at least a first user profile on a social network service; and
facilitating transfer of the at least one unique product identification number from the first user profile to a second user profile on a social network service.

2. The method as claimed in claim 1, which includes a prior step of registering at least two user profiles on a social network service.

3. The method as claimed in claim 1, which includes the prior step of allocating the unique product identification number to goods to be transferred from the first user profile to the second user profile.

4. The method as claimed in claim 3, in which allocating the unique product identification number to goods includes creating a unique machine-readable tag.

5. The method as claimed in claim 4, in which the machine-readable tag includes any one of an optical readable label and a contactless radio-frequency identification tag.

6. The method as claimed in claim 2, in which the registering of the at least two user profiles on a social network service includes creating a user profile, comprising of unique user identification data.

7. The method as claimed in claim 6, in which the user identification data includes any one or more of a name and surname, a physical address, contact details of a user, and an identification picture.

8. The method as claimed in claim 1, in which facilitating transfer of at least one unique product identification number includes associating the at least one unique product identification number with a second user profile and dissociating the unique product identification number from the first user profile.

9. The method as claimed in claim 8, in which the facilitating transfer of the at least one unique product identification number is related to the transfer of goods from a first owner to a second owner.

10. The method as claimed in claim 8, in which the facilitating transfer of at least one unique product identification number includes obtaining authorisation from a government institution for the transfer of goods.

11. A social networking service application, which includes:
a social networking service user profile database;
a unique product identification database containing product identification numbers; and
association means operable to associate unique product identification numbers from the product identification database with user profiles from the user profile database.

12. The social networking service application, as claimed in claim 11, in which the association means is in the form of a lookup table comprising user profile data, and unique product identification data, associated with each other.

13. The social networking service application, as claimed in claim 11, in which the user profile database includes data fields comprising any one or more of user names, addresses, contact details for the users, and an identification picture.

14. The social networking service application, as claimed in claim 11, in which the unique product identification database includes data fields comprising any one or more of a barcode, a QR code and a product description.

15-18. (canceled)
